(19) United States
(12) Patent Application Publication
(10) Pub. No.: US 2015/0094150 A1
(43) Pub. Date: Apr. 2, 2015

(54) OPERATION OF A BROWSER-INCOMPATIBLE APPLICATION WITHIN A BROWSER

(71) Applicant: Zynga Inc., San Francisco, CA (US)

(72) Inventors: James Peter Gregory, Berkeley, CA (US); Timothy J.O. Catlin, San Mateo, CA (US)

(73) Assignee: Zynga Inc., San Francisco, CA (US)

(21) Appl. No.: 14/069,849

(22) Filed: Nov. 1, 2013

Related U.S. Application Data
(60) Provisional application No. 61/884,717, filed on Sep. 30, 2013.

(51) Int. Cl. A63F 13/30

(52) U.S. Cl. CPC A63F 13/12
USPC 463/42

(57) ABSTRACT

Disclosed in some examples are methods, machine readable mediums, and systems for allowing a user to utilize an application that is not normally browser-compatible in a browser. In some examples, this may be accomplished by utilizing a source-to-source compiler to compile the source code of the browser-incompatible application itself into browser-compatible code (such as JavaScript). In other examples, this may be accomplished by utilizing a source-to-source compiler to compile the source code of a virtual machine into browser-compatible code (such as JavaScript). Once the virtual machine is rendered browser-compatible, the virtual machine may execute within the browser, and applications that are natively executable on the execution environment simulated by the virtual machine may then be executed within the virtual machine (and by extension, within the browser).

### CLAIM OF PRIORITY

This patent application claims the benefit of priority, under 35 U.S.C. Section 119 to U.S. Provisional Patent Application Ser. No. 61/884,717, entitled “OPERATION OF A BROWSER-INCOMPATIBLE APPLICATION WITHIN A BROWSER,” filed on Sep. 30, 2013, to James Gregory, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Zynga, Inc., All Rights Reserved.

### BACKGROUND

Browser-compatible applications have increased in popularity in recent years. These applications are convenient to deploy and update, and are easy for users to access. These applications may be platform independent. Example browser compatible applications may include gaming applications.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a line drawing of a screen shot of a browser-compatible application and a browser-incompatible application executing inside a browser according to some examples of the present disclosure.

FIG. 2 shows a line drawing of a screen shot of multiple mobile versions of an application simultaneously executing within a browser according to some examples of the present disclosure.

FIG. 3 shows a flowchart of a first method of enabling execution of a browser-incompatible application in a browser according to some examples of the present disclosure.

FIG. 4 shows an example application stack according to some examples of the present disclosure.

FIG. 5 shows an example application stack for running a virtual machine in a browser according to some examples of the present disclosure.

FIG. 6 shows an example application stack according to some examples of the present disclosure.

FIG. 7 shows a flowchart of a method of utilizing a virtual machine in a browser is shown according to some examples of the present disclosure.

FIG. 8 shows a flowchart of a method of bypassing one or more layers in the software stack according to some examples of the present disclosure.

FIG. 9 shows a schematic of a system of executing browser-incompatible applications on a browser according to some examples of the present disclosure.

FIG. 10 shows a schematic of a machine according to some examples of the present disclosure.

### DETAILED DESCRIPTION

Many applications are not browser-compatible applications. These applications typically require specific platforms (either hardware or software) and typically require downloading and installing the application. For example, a user may be required to go to an application server (e.g., an “App” store), download the application, install it, accept permissions and the like. This is inconvenient for the user and prevents many users for trying applications they may otherwise enjoy.

Browser based applications on the other hand typically are delivered to a user's browser based upon the user navigating to a particular Universal Resource Locator (URL—e.g., a web address) and accepting the download. Every time the user visits the URL the most recent version of the application may be delivered to the user. These applications are convenient for users to use.

Converting browser in-compatible applications to browser compatible applications typically required rewriting the code to a browser compatible application such as JavaScript or FLASH. This can be expensive and costly.

Additionally, because of the barriers presented by browser incompatible applications (e.g., the separate download and execution mentioned previously), it becomes difficult to effectively promote a browser incompatible application in a browser compatible application. This effectively limits cross-promotional success.

Disclosed in some examples are methods, machine readable mediums, and systems for allowing a user to utilize an application that is not normally browser-compatible in a browser without expensive code rewrite. In some examples, this may be accomplished by utilizing a source-to-source compiler to compile the source code of the browser-incompatible application into a browser-compatible application (such as JavaScript). In other examples, this may be accomplished by utilizing a source-to-source compiler to compile the source code of a virtual machine into browser-compatible code (such as JavaScript). Once the virtual machine is rendered browser-compatible, the virtual machine may execute within the browser, and applications that are natively executable on the execution environment simulated by the virtual machine may then be executed within the virtual machine (and by extension, within the browser).

Example applications of this include allowing users of browser-compatible applications on one execution environment to preview or begin play with applications compatible with a second, different, execution environment. For example, users of browser-compatible online games, such as FarmVille™ developed by Zynga, Inc., of San Francisco, Calif., may reach predetermined states of the game in which they need to satisfy a particular condition to move to a different state. For example, the player may be required to purchase in-game objects, such as water to grow crops. In other examples, users may have to wait a predetermined period of time before in game objects such as “energy” regenerate before they can continue. When players reach these situations, players may be presented with an opportunity to try out a different, browser-incompatible application, such as a mobile-based game, in their browser. This may make waiting for the in-game object to regenerate more fun and keep the player engaged in the game. The player may be presented with the option to play the entire browser-incompatible application, or portions of it. Additionally, players may be rewarded for playing the normally browser-incompatible application by having their in-game object regenerate faster or by awarding the player the in-game object in lieu of purchasing it, or at a reduced cost. In some examples, the particular progress or state that the user achieves in the normally browser-incompatible application when presented in the browser may be saved by a network based server. Subsequent uses of this application in the browser may revert to the saved state. Additionally, subsequent uses of the application in the native application environment, may also revert to the saved state. For example, an Android based game played in the browser may save the user's progress on a server. Upon downloading the Android version on an Android phone, the user may pickup where they left off in the browser. In this way, developers may promote mobile based games to players of the browser based games.

### Direct Conversion of the Browser Incompatible Application

Applications that are browser-compatible include applications that are executable by the browser, either through code normally part of the browser (such as a JavaScript interpreter), or through one or more widely available plug-ins, controls, or extensions (e.g., Adobe FLASH) without modification to the source code of the application. An application that is not browser-compatible may be any application whose compiled or interpreted source code is not normally executable or interpretable in standard Internet browsers without modification. For example, the browser-incompatible applications may be written and/or compiled for an execution environment that is different from the execution environment of the browser (e.g., an application written for a different processor architecture, a different Operating System, or both), or an application that does not execute within a browser (for example, a Windows.exe executable binary file application). An execution environment may be defined for example by the type of computer processor and the operating system. In some examples the browser-incompatible application may be an application that is written for execution on a mobile device (e.g., an “app” that is configured for execution on an Android mobile device or an iPhone smartphone). Thus the native browser may execute the mobile device application and may present output of the program to the user, and process input from the user as if the non-native application were executing on the non-native platform.

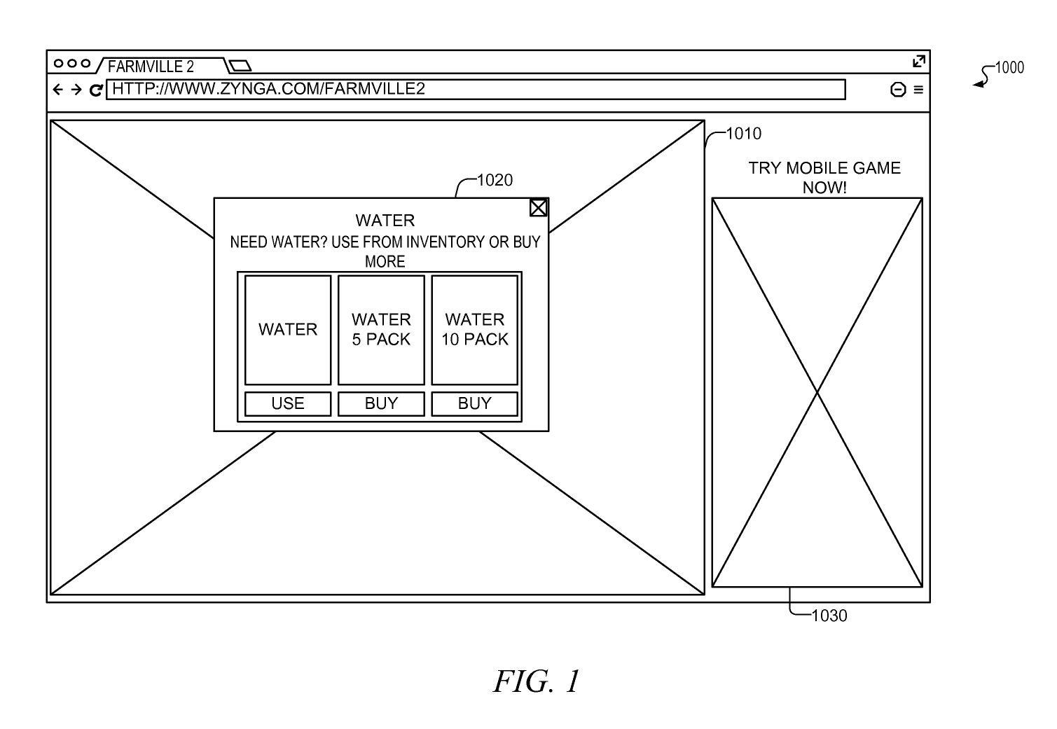

Turning now to FIG. 1, an example line drawing of a screen shot 1000 of a browser-compatible application and a browser-incompatible application executing inside a browser is shown. In the Example of FIG. 1, the player is playing a farming simulation game in browser portion 1010 and needs to buy water to continue to perform an in-game action, specifically, to water planted crops. Prompt 1020 prompts the user to purchase additional water. In some examples, rather than requiring the player to purchase additional water, the player may play a demo of a mobile game. The mobile game may be displayed in a browser portion 1030. For example, browser portion 1030 may be a frame dynamically launched within a web site, such as an iframe. The user may continue to monitor the progress of the main, browser based game in portion 1010 while playing the browser-incompatible game (as rendered browser-compatible by virtue of the methods disclosed herein). In some examples, if the user plays the mobile based game for a predetermined period of time, the user is allowed to purchase the in-game object (e.g., water) of the browser-compatible game for a reduced cost, or even obtain the object for free. In other examples, reaching a predetermined objective (e.g., advancing to a particular game level, obtaining an in-game object, defeating an in-game adversary, or the like) in the mobile game will allow the user to purchase the in-game object (e.g., water) for a reduced cost, or for free.

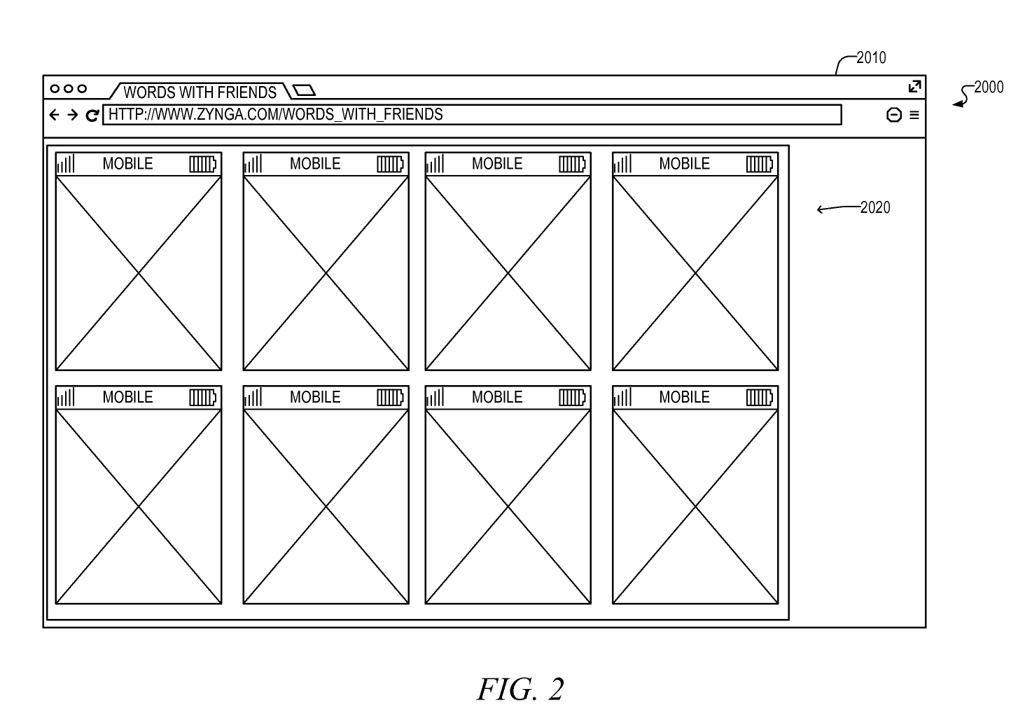

The methods, systems, and machine readable mediums disclosed herein are not limited to presenting a browser-incompatible application in conjunction with a browser-compatible application. For example, the methods, systems, and machine readable mediums may allow users to utilize multiple browser-incompatible applications in the browser at the same time. For example, FIG. 2 shows a line drawing of a screenshot of eight mobile versions of an application 2020 simultaneously executing within a browser 2010. Each of the eight applications 2020 are simultaneously playable by the user. Each application may execute inside a different frame, such as an iframe. This may be useful for games where timed inputs are not critical, such as turn based strategy games. An example game may include Words with Friends™ developed by Zynga, Inc., of San Francisco Calif. Other example usages may include presenting the game in a prompt, a news feed, or other user interface element of a browser-compatible application.

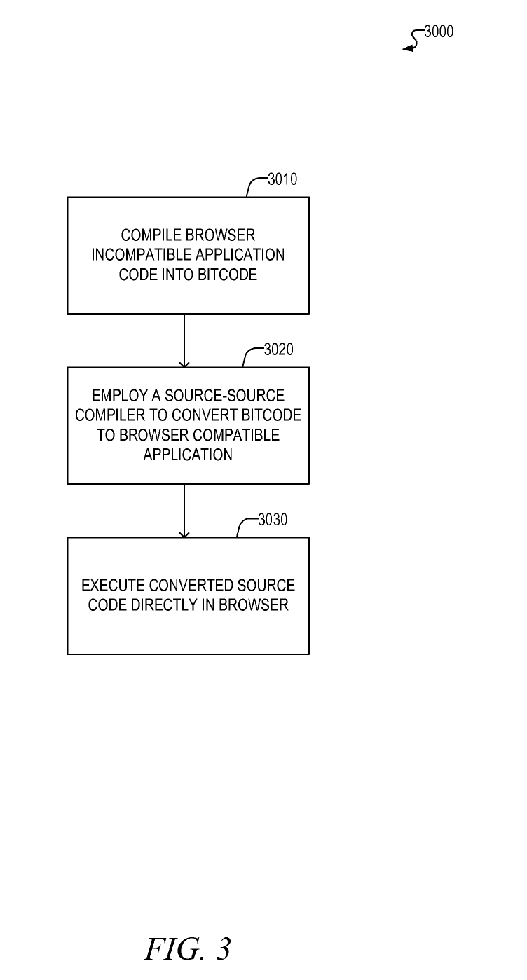

Turning now to FIG. 3, a flowchart of a first method 3000 for enabling execution of a non-browser-compatible application in a browser is shown. At operation 3010, the source code for the browser-incompatible application is compiled into an intermediate form. In one example, this form is bitcode. In general the intermediate form is any form that is useable by a source-to-source compiler to convert it into a different programming language or execution environment. For example, the non-browser executable application code may be written in a C, C++ or Objective C programming language and compiled into this bitcode by compiler systems such as Clang/LLVM. LLVM is a compiler developed by the University of Illinois at Urbana-Champaign. Clang is a compiler front end for the C, C++, Objective-C and Objective-C++ programming languages. Clang uses LLVM as its back end. Clang is developed by Apple, Inc., of Cupertino Calif., and Google Inc., of Mountain View Calif. The bitcode that is produced may be an abstract encoding of structured data containing tags and nested structures. The bitcode may include encoding primitives (like variable bit-rate integers), blocks (which define nested content), data records (which describe entities within the bitcode), abbreviations (which specify compression optimizations for the file), and the like. A full description of bitcode produced by the LLVM compiler can be found accompanying the LLVM documentation.

At operation 3020, this bitcode may then translated by a source to source compiler to a browser-compatible application (e.g., JavaScript code). For example, the open source tool Emscripten may be utilized. Emscripten takes as input LLVM bitcode and emits a JavaScript file. Emscripten was developed by Alon Zakai and is available on the web-based hosting service for software development projects GITHUB. Another example source to source compiler may be Adobe CrossBridge which converts C/C++ code to Adobe Flash applications which are browser compatible. CrossBridge is developed by Adobe Systems Inc., of San Jose, Calif. At operation 3030 this JavaScript code may then be natively executed by the browser. In some examples, this JavaScript may be executed as part of a renderable Hyper Text Markup Language document.

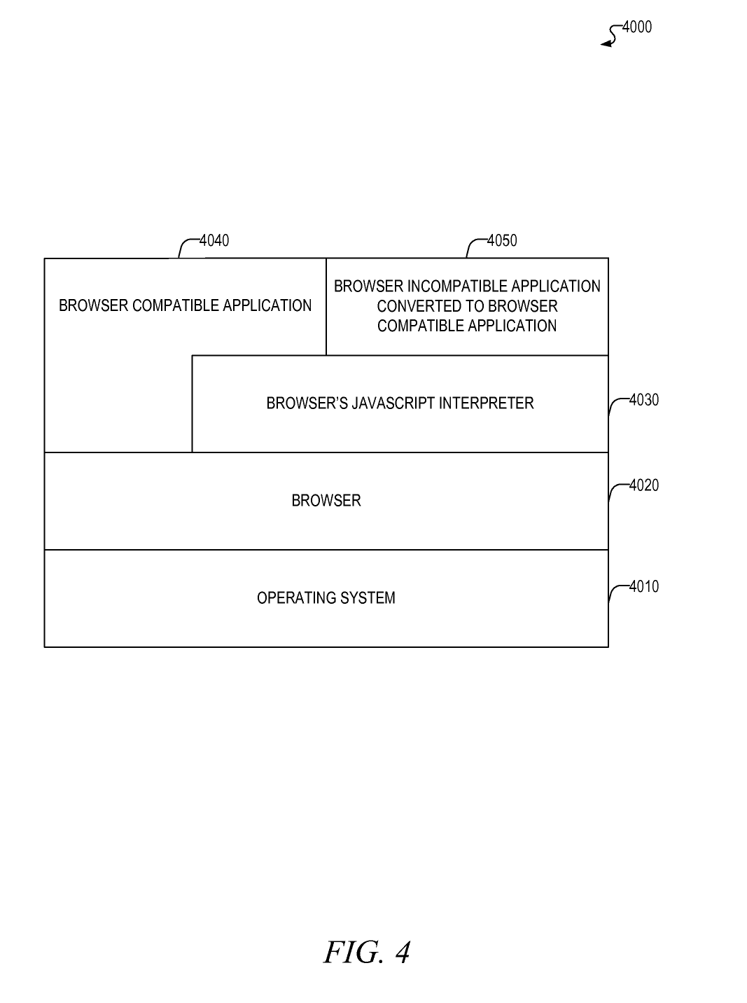

An example application stack 4000 is shown in FIG. 4. An operating system 4010 may be one or more software applications that manages hardware resources and provides common services for other applications. Example operating systems may include Microsoft Windows™, Apple iOS™, MAC OS™, Android™, and the like. A browser 4020 executes on top of and utilizes the functionality provided by operating system 4010. Example browsers include Chrome™ developed by Google, Inc., of Mountain View Calif., Safari™ developed by Apple, Inc., of Cupertino Calif., Internet Explorer™ developed by Microsoft of Redmond, Wash., and Firefox™ developed by the Mozilla Foundation of Mountain View Calif. Browser 4020 may contain a JavaScript or other scripting language interpreter 4030. JavaScript engine or interpreter 4030 interprets and executes JavaScript as part of Browser 4020. Browser-compatible application 4040 may execute within a browser window and may include portions written in JavaScript and executing using the JavaScript interpreter 4030. Other portions of browser executable application 4040 may feature content from Adobe Flash, Microsoft Silverlight, HTML, XML, Python, or other languages that are interpretable and executable in browser 4020. Browser-incompatible application 4050 as compiled by the source-to-source compiler into JavaScript, may have its contents executed by the JavaScript interpreter 4030 and may also execute inside a browser window.

### Virtual Machine

In some examples, rather than convert each browser incompatible application into a browser compatible application, another method is to run a virtual machine within the browser which emulates the native architecture of these browser incompatible applications. The browser incompatible applications may then be executed within the browser without any modification to the browser incompatible applications through the virtual machine. A virtual machine may be implemented as a software application which emulates a particular computer architecture. A computer architecture may be thought of as a particular processor, a particular operating system, or both.

In some examples, an existing, browser-incompatible virtual machine may be converted to be a browser-compatible virtual machine using the methods previously described. For example, a browser-incompatible iOS virtual machine may be converted to a browser-compatible application and subsequently executed within the browser. iOS compatible applications may then be executed in the browser without modification of the applications to a browser-compatible form by executing within the iOS virtual machine of the browser. Likewise, a browser-incompatible Android virtual machine may be converted to a browser-compatible application and subsequently executed within the browser. Android compatible applications may then be executed in the browser without modification of the applications to a browser-compatible form by executing within the Android virtual machine of the browser.

While one method may be to convert a virtual machine to a browser-compatible application, another option would be to create a virtual machine that is browser compatible. For example, create an iOS or Android virtual machine in JavaScript.

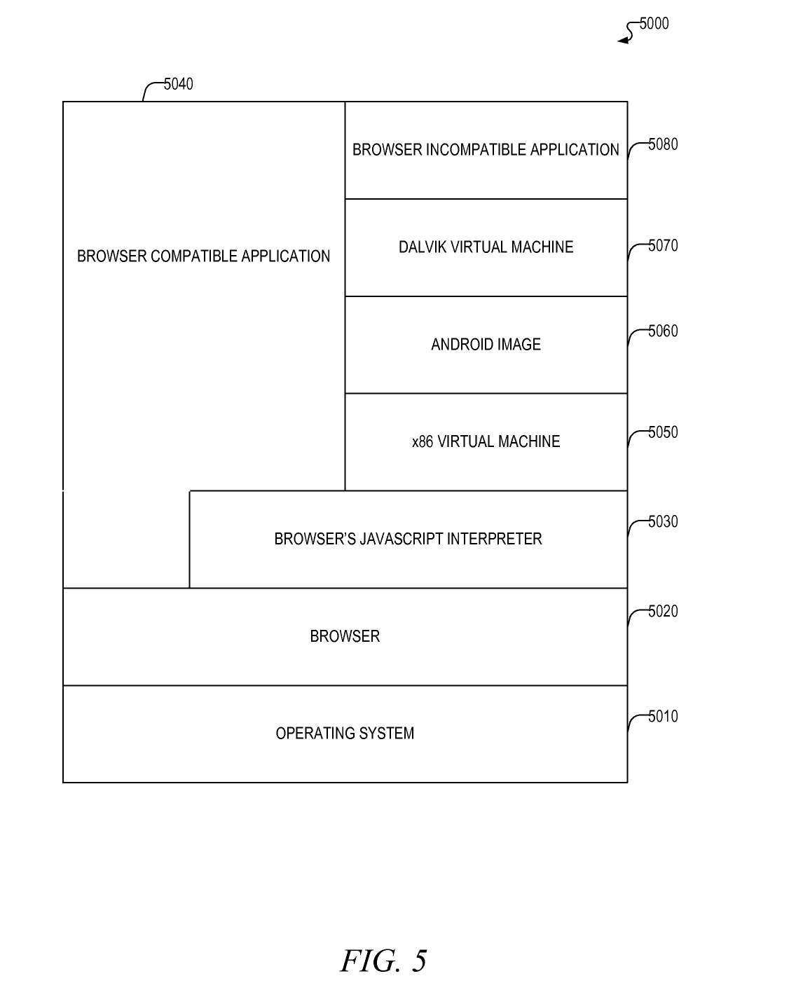

FIG. 5 shows an example software stack 5000 for running a virtual machine in a browser according to some examples of the present disclosure. An operating system 5010 may be one or more software applications that manages hardware resources and provides common services for other applications. Example operating systems may include Microsoft Windows™, Apple iOS™, MAC OS™, Android™, and the like. A browser executes on top of and utilizes the functionality provided by operating system 5010. Example browsers include Chrome™ developed by Google, Inc., of Mountain View Calif., Safari™ developed by Apple, Inc., of Cupertino Calif., Internet Explorer™ developed by Microsoft of Redmond, Wash., and Firefox™ developed by the Mozilla Foundation of Mountain View Calif. Browser includes JavaScript interpreter 5030. JavaScript interpreter 5030 (which is sometimes referred to as a JavaScript engine) interprets and executes JavaScript as part of Browser 5020. Browser-compatible application 5040 may include portions written in JavaScript and executing using the JavaScript interpreter 5030. Browser-compatible application 5040 may execute within a window of browser 5020. Other portions of browser-compatible application may feature Adobe Flash, Microsoft Silverlight, HTML, XML, Python, or other languages that are interpretable or executable in browser 5020.

An x86 virtual machine application 5050, as compiled by the source-to-source compiler into JavaScript, may have its contents executed by the JavaScript interpreter 5030 and may run inside the browser 5020. The x86 virtual machine 5050 may simulate an Intel 8086 processor architecture, for example. Other x86 compatible applications 5060-5080 may run within the x86 virtual machine 5050.

For example, an Android image 5060 may run on the x86 virtual machine 5050. Android image 5060 may be an Android Operating System (Android is an operating system developed by Google, Inc., of Mountain View Calif.) that is compiled for an x86 platform. Android image 5060 is not browser-compatible when not running on the x86 virtual machine 5050. Android image 5060 may execute a Dalvik virtual machine 5070. Dalvik virtual machine may also not be browser-compatible. Dalvik is a process virtual machine that runs the applications on Android devices by interpreting Java byte code and in many cases utilizing Just In Time (JIT) compilation of the bytecode. Browser-incompatible application 5080 may then run on top of the Dalvik Virtual Machine 5070.

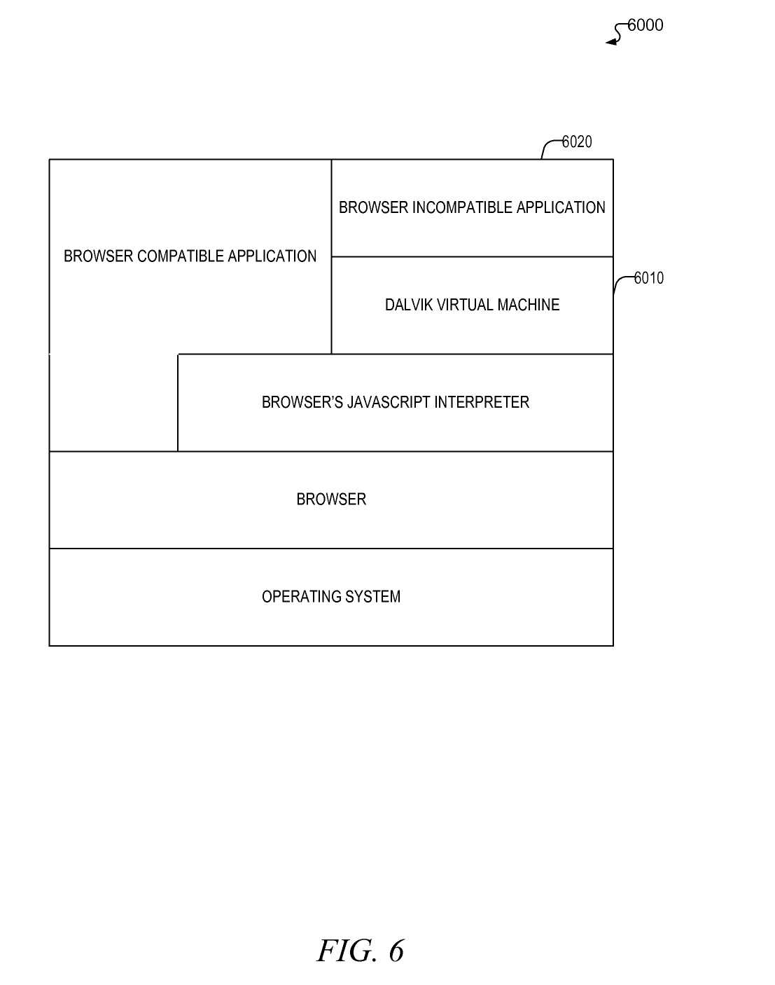

FIG. 6 shows another example software stack 6000. In this example, the Dalvik virtual machine 6010 is converted to a browser-compatible application and run in the browser, rather than compiling an x86 virtual machine to JavaScript and then running an Android image (which then runs the Dalvik virtual machine). This removes several layers. Browser-incompatible application 6020 then executes within the Dalvik virtual machine 6010.

While the software stacks of FIGS. 5 and 6 have more layers than the software stack of FIG. 4, the advantage of using a virtual machine is that once a stable virtual machine has been compiled to JavaScript (or in other examples, written in JavaScript to start), the browser incompatible application (e.g., the game) may be executed without modification to the source, or without needing to cross-compile the source. The application binary may be simply executed inside the virtual machine, inside the browser.

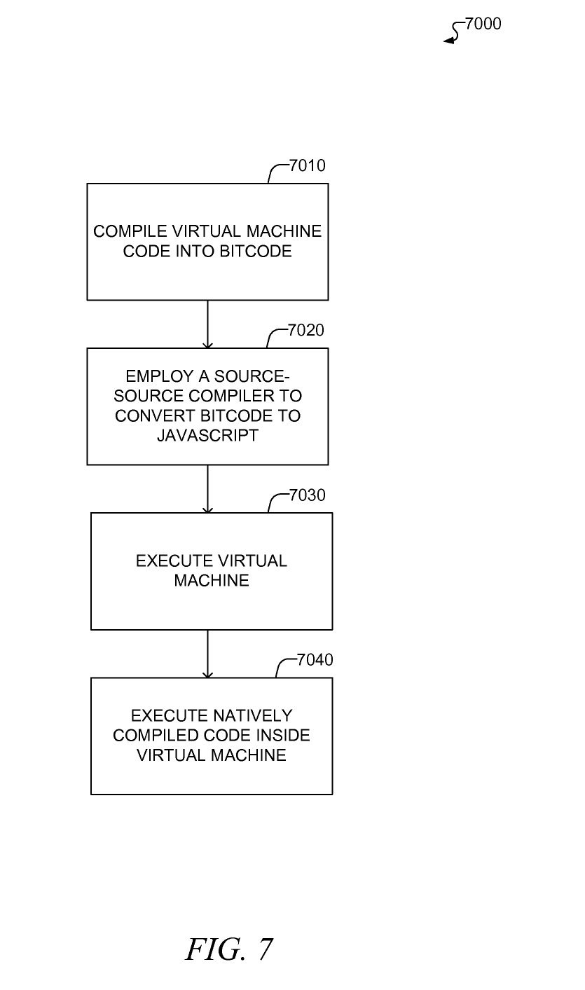

Turning now to FIG. 7, a flowchart of an example method 7000 of utilizing a virtual machine in a browser is shown according to some examples of the present disclosure. At operation 7010, the virtual machine application source code is compiled into bitcode as was done for the non-browser based application in FIG. 3. At operation 7020, a source-to-source compiler such as Emscripten is utilized to convert the bitcode to a browser-compatible application (e.g., JavaScript). At operation 7030 the browser executes the converted virtual machine. At operation 7040 applications native to the architecture simulated by the virtual machine (in some examples, applications not native to the architecture executing the browser) may be executed and presented in the browser inside the virtual machine.

In some examples, multiple layers of virtual machines make the execution of the applications, such as application 5080, 6020 slow. Several optimizations may be utilized in order to increase performance. For example, in some applications, drawing graphics may consume a significant amount of the execution time of the application. Graphics on applications in some examples are implemented using calls to a graphics library, such as an OpenGL graphics library. These calls then are passed through each layer of the software stack (e.g., in FIG. 5, the OpenGL call is translated by the x86 virtual machine into instructions to plot pixels and then finally through the JavaScript interpreter to the browser and then to the OS.) This is inefficient, as the browser has been optimized to implement WebGL, a related graphics library. In some examples, the virtual machine may be optimized to recognize OpenGL library calls and then directly pass those calls to the browser as WebGL calls and then return the WebGL result as an OpenGL result.

This concept may extend to other routines, calls, and functionality. For example, XML parsing is very efficient on the browser. Any XML parsing task may be passed directly to the browser to take advantage of the efficiency gains using the methods disclosed herein

Directly passing calls to a different layer in the software stack may be accomplished in several ways. In some examples, a new instruction may be added to a virtual machine application (e.g., an x86 virtual machine) to pass certain instructions directly to layers below. In some examples, the browser-incompatible applications may then make use of this instruction if they are aware of their execution environment (e.g., that they are executing on a virtual machine). In other examples, these applications are transparent to their current execution environment. In these examples, the particular libraries utilized by the applications may be customized to intercept these calls and replace them with optimized calls and utilize the custom instruction.

For example, in the case of graphics, a modification to the OpenGL library running on the x86 virtual machine may intercept OpenGL calls, and instead of generating instructions to a CPU or GPU to draw pixels (these instructions would then be handled by the browser), the OpenGL library may convert the OpenGL calls to WebGL and then utilize the special instruction on the virtual machine to pass the instructions directly to the browser (e.g., the JavaScript interpreter) without execution by the virtual machine itself.

The special instruction on the virtual machine may be an instruction in which a memory address is passed in that holds the instructions along with a size or other value to inform the virtual CPU in the virtual machine where the instructions stop and a memory location to store the result in. The virtual machine then passes this chunk of memory to the browser as executable code and then puts the result in the memory address designated for the result.

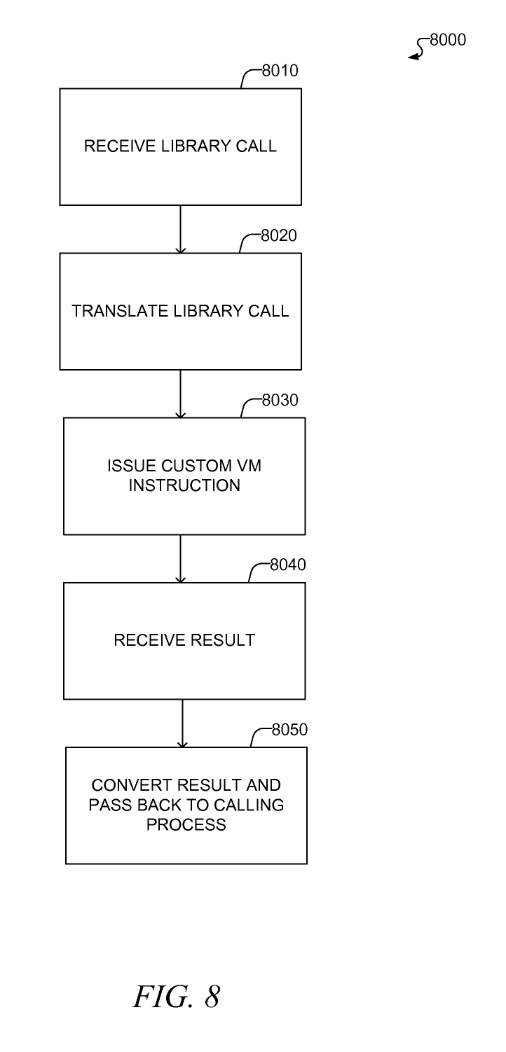

FIG. 8 shows a flowchart of an example method 8000 of bypassing one or more layers in the software stack according to some examples of the present disclosure. At operation 8010 the virtual machine receives the library call (e.g., OpenGL). At operation 8020, if necessary, this call may be translated into an equivalent function call on the target lower level application. For example, the system may have a table that maps an OpenGL call to a WebGL call and vice versa. This table may also have the mapping of the function arguments from OpenGL to WebGL. Using this table, the call is translated and placed into a particular memory location. At operation 8030, a custom virtual machine instruction is issued with the memory location where the library call resides. This instruction is then issued to the browser by the virtual machine. At operation 8040 the result is received. At operation 8050, the result is converted (if necessary) from the equivalent result (e.g., from a WebGL result to an OpenGL result) and passed back to the calling process.

In other examples, instead of utilizing a special instruction in the virtual machine, rather than modifying a virtual machine, a device driver may be utilized. The device driver may register with the virtual machine and may receive instructions from the custom library and pass those on to the other software layers without needing a special instruction. This solution may not require any modification of the virtual machine. Instead, a software module implementing the virtual device driver may be utilized.

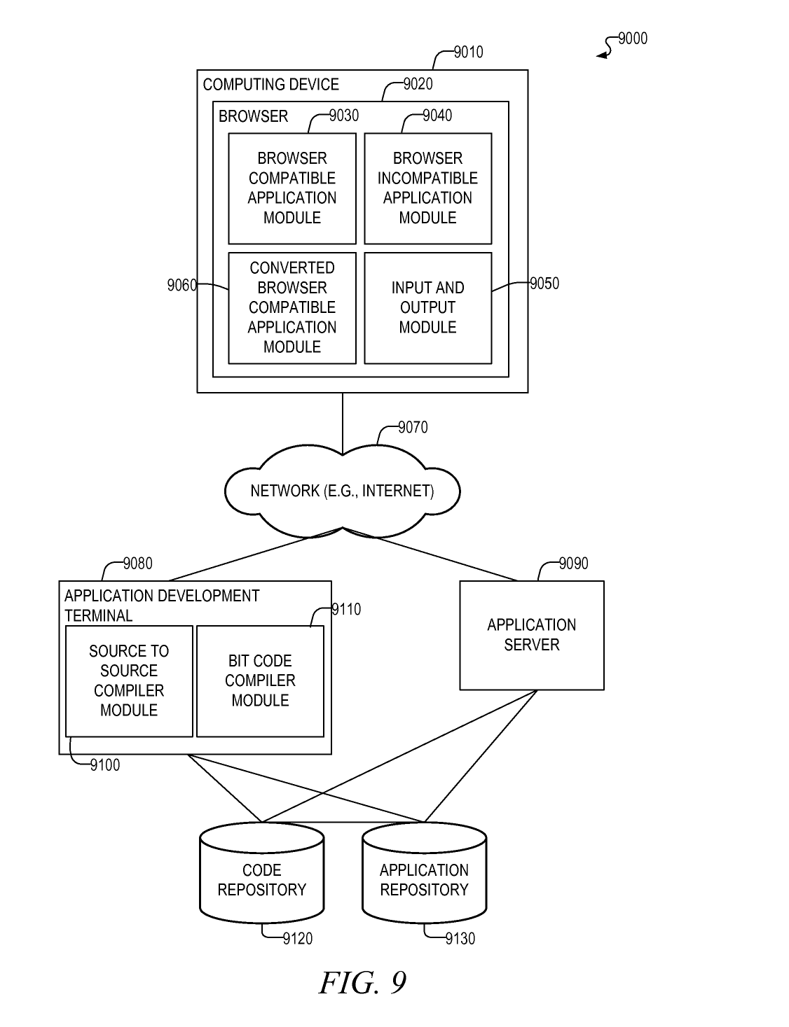

FIG. 9 shows a schematic of a system 9000 of executing browser-incompatible applications on a browser. Computing device 9010 may be any computing device capable of executing an Internet browser 9020 and browser-compatible application module 9030, converted browser-compatible application module 9060, input and output module 9050, and browser-incompatible application module 9040. Example computing devices may include a desktop personal computer, a laptop computer, a tablet computer, a smartphone, a cellular phone, or the like. Computing device 9010 may include browser module 9020. Browser module 9020 may retrieve, present, and traverse information resources across a network such as the Internet. Browser module 9020 may present one or more applications as part of the display of those information resources. For example, Browser module 9020 may execute one or more scripting applications, passing user input to the scripting application, and processing program output (e.g., to the display). Browser 9020 may include input and output module 9050. Input and output module 9050 may contact server computing devices over networks, such as network 9070. Input and output module 9050 may download one or more information resources, such as browser-compatible application modules 9030, and present the applications on a display device, and accept user input from a user input device, passing the user input to the application modules 9030. For example, input and output module 9050 may respond to a request from a user of computing device 9010 to download a resource, such as a resource at application server 9090 by contacting application server 9090 across network 9070 and receiving content such as a browser-compatible application module. In a more specific example, the browser may download a browser-compatible game from a game server. Browser-compatible application module 9030 may implement the functionality of any browser-compatible application, for example, browser-compatible application module 9030 may implement a browser-based application (also called a “Web Application”). Example applications may include games (e.g., such as Zynga's FarmVille 2), productivity applications (e.g., such as Google's Calendar and Spreadsheet applications), communication applications (e.g., such as GMAIL™ provided by Google), and the like.

In some examples, the input and output module may retrieve a converted browser-compatible application module 9060. The converted browser-compatible application module 9060 may be an application that is not compatible with a browser that has been converted according to the methods described in the present disclosure. This application may implement any functionality desired. For example, the converted browser-compatible application module 9060 may be a game that has a native execution environment that is different than that provided by the computing device 9010. In some examples, either the browser-compatible application module 9030, or the converted browser-compatible application module 9060 may be a virtual machine. In these examples, various browser-incompatible application modules 9040 may be retrieved from a server, such as an application server 9090, and executed inside browser 9020 as a web application.

Network 9070 may be or include portions of the Internet, a Local Area Network (LAN), a Wide Area Network (WAN), a cellular network (such as a 4^{th} Generation Long Term Evolution wireless network), a Wireless LAN (such as an IEEE 802.11 network), and the like.

Application development terminal 9080 may be any computing device capable of converting an application that is browser-incompatible to an application that is compatible with a browser. Bitcode compiler module 9110 may take the source code of the incompatible application and compile it to bitcode. In some examples, this may be an LLVM compiler. Source to source compiler module 9100 may take the bitcode and transform it into a browser-compatible application (e.g., JavaScript). In some examples, further compilation or interpretation may be done to ensure compatibility with the browser.

Source code for the application development terminal may be stored in one or more code repositories 9120. Applications that are ready for deployment to end user computing devices may be stored in an application repository 9130. The repositories 9120 and 9130 may be any storage device capable of storing code and applications and delivering them on-request to authorized computing terminals, such as application development terminal 9080 and application server 9090. They may include one or more storage devices and media, such as hard disks, magnetic drives and tape, optical drives and optical media, solid state memory, and the like. They may also include computing resources and have one or more database applications executing on those computing resources to manage the data stored thereon.

Application server 9090 may respond to requests for both browser-compatible and browser-incompatible applications from computing devices 9010.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computing devices (e.g., a standalone, client or server computing device) or one or more hardware modules of a computing device (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing device can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

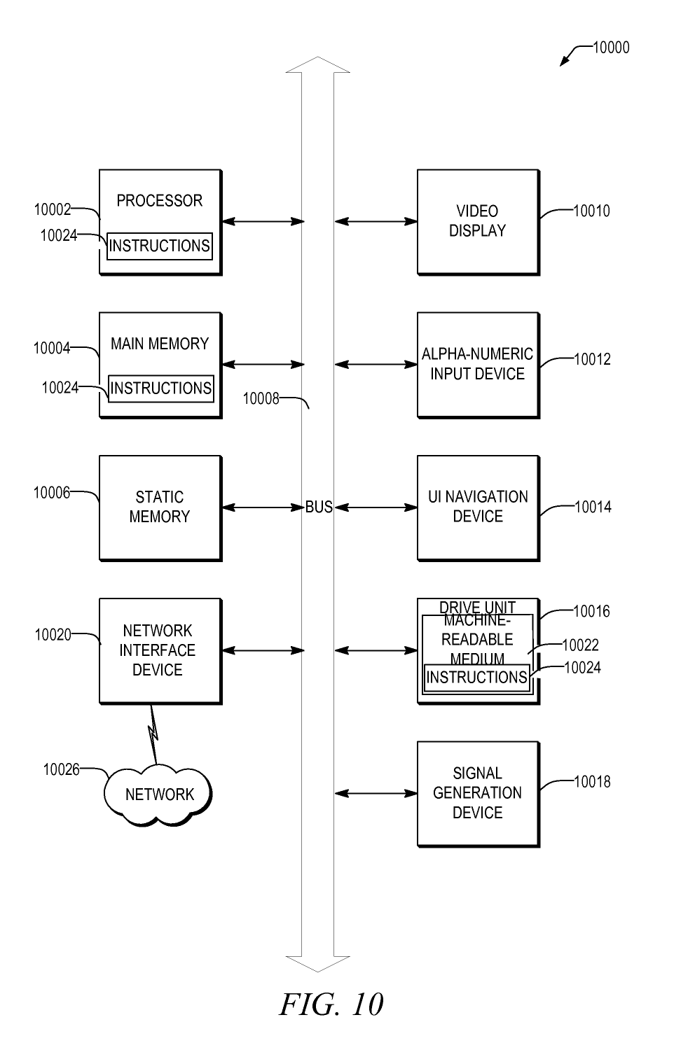

FIG. 10 is a block diagram of machine in the example form of a computing device 10000 within which instructions, for causing the machine to perform any one or more of the methodologies discussed herein, may be executed. For example, any one of the components shown in FIG. 9 may be or contain one or more of the components described in FIG. 10. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a notebook PC, a docking station, a wireless access point, a tablet PC, a set-top box (STB), a PDA, a cellular telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The machine may contain components not shown in FIG. 10 or only a subset of the components shown in FIG. 10.

The example computing device 10000 includes a processor 10002 (e.g., a central processing unit (CPU), a graphics processing unit (GPU) or both), a main memory 10004 and a static memory 10006, which communicate with each other via a bus 10008. The computing device 10000 may further include a video display unit 10010 (e.g., a liquid crystal display (LCD) or a cathode ray tube (CRT)). The computing device 10000 may also include an alphanumeric input device 10012 (e.g., a keyboard), a user interface (UI) navigation device 10014 (e.g., a mouse), a disk drive unit 10016, a signal generation device 10018 (e.g., a speaker) and a network interface device 10020.

### Machine-Readable Medium

The disk drive unit 10016 includes a machine-readable medium 10022 on which is stored one or more sets of instructions and data structures (e.g., software) 10024 embodying or used by any one or more of the methodologies or functions described herein. The instructions 10024 may also reside, completely or at least partially, within the main memory 10004, static memory 10006, and/or within the processor 10002 during execution thereof by the computing device 10000, the main memory 10004 and the processor 10002 also constituting machine-readable media.

While the machine-readable medium 10022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 10024 may further be transmitted or received over a communications network 10026 using a transmission medium. The instructions 10024 may be transmitted using the network interface device 10020 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software. Network interface 10020 may wirelessly transmit data and may include an antenna.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Other Notes and Examples

Example 1 includes subject matter (such as a method, means for performing acts, machine readable medium that is not a transitory propagating signal including instructions for presenting a gaming application in a web browser) comprising: presenting a first gaming application that is web browser executable in the browser in response to a user request; determining that the user has reached a predetermined state in the first gaming application; responsive to determining that the user has reached the predetermined state, causing a source to source compiled application produced from source code of an application that is not web browser executable to execute in the web browser, the source to source compiled application presenting a second gaming application; responsive to reaching a second predetermined state in the second gaming application, changing the first gaming application that is web browser executable to a third predetermined state.

In example 2, the subject matter of Example 1 may optionally include, wherein the predetermined state is a prompt for the user to buy an in-game item.

In example 3, the subject matter of any one or more of examples 1-2 may optionally include, wherein the predetermined state is a lack of an in-game item that is necessary to continue to play the game.

In example 4, the subject matter of any one or more of examples 1-3 may optionally include, wherein the third predetermined state is a reduction to a cost to buy an in-game item.

In example 5, the subject matter of any one or more of examples 1-4 may optionally include, wherein the first gaming application that is web browser executable includes JavaScript code.

In example 6, the subject matter of any one or more of examples 1-5 may optionally include wherein causing a source to source compiled application produced from source code of an application that is not web browser executable to execute in the web browser comprises: compiling source code of the application that is not web browser executable to bitcode; and source to source compiling the bitcode to a web browser executable format.

In example 7, the subject matter of any one or more of examples 1-6 may optionally include, wherein the source to source compiled application is a virtual machine application that simulates an execution environment of a platform that is different than a platform on which the browser is executing, and wherein presenting the second gaming application comprises executing a second gaming application that is executable on the execution environment simulated by the virtual machine in the virtual machine to present the second gaming application.

In example 8, the subject matter of any one or more of examples 1-7 may optionally include, wherein the virtual machine application is a Dalvik virtual machine application, and wherein the execution environment of the platform that is different than the platform on which the browser is running comprises an Android operating system.

In example 9, the subject matter of any one or more of examples 1-8 may optionally include, wherein the virtual machine application is an x86 virtual machine running an Android operating system compiled for an x86 processor, and wherein the execution environment of the platform that is different than the platform on which the web browser is running comprises an Android operating system.

Example 10, includes or may optionally be combined with the subject matter of any one of examples 1-9 to include subject matter (such as a device, apparatus, or machine) comprising: a web browser compatible application module configured to: present a first gaming application that is web browser executable in the browser in response to a user request; determine that the user has reached a predetermined state in the first gaming application; responsive to determining that the user has reached the predetermined state, notify a converted web browser compatible application module to begin execution of a source to source compiled application produced from source code of an application that is not web browser executable in the web browser; the converted web browser compatible application module configured to: execute the source to source compiled application responsive to receiving the notification from the web browser compatible application module, the source to source compiled application presenting a second gaming application; determine that the a second predetermined state has been reached in the second gaming application; and wherein the web browser compatible application module is configured to change the state of the first gaming application that is web browser executable to a third predetermined state responsive to reaching a second predetermined state in the second gaming application.

In example 11, the subject matter of any one or more of examples 1-10 may optionally include, wherein the predetermined state is a prompt for the user to buy an in-game item.

In example 12, the subject matter of any one or more of examples 1-10 may optionally include wherein the third predetermined state is a reduction to a cost to buy an in-game item.

In example 13, the subject matter of any one or more of examples 1-12 may optionally include a bit code compiler module configured to: compile source code of the application that is not web browser executable to bitcode; and a source to source compiler module configured to: source to source compile the bitcode to a web browser executable format.

In example 14, the subject matter of any one or more of examples 1-13 may optionally include wherein the source to source compiled application is a virtual machine application that simulates an execution environment of a platform that is different than a platform on which the browser is executing, and wherein the converted web browser compatible application module is configured to present the second gaming application by at least executing a second gaming application that is executable on the execution environment simulated by the virtual machine in the virtual machine to present the second gaming application.

What is claimed is:

1. A method for presenting a gaming application in a web browser, the method comprising:
presenting a first gaming application that is web browser executable in the browser in response to a user request;
determining that the user has reached a predetermined state in the first gaming application;
responsive to determining that the user has reached the predetermined state, causing a source to source compiled application produced from source code of an application that is not web browser executable to execute in the web browser, the source to source compiled application presenting a second gaming application;
responsive to reaching a second predetermined state in the second gaming application, changing the first gaming application that is web browser executable to a third predetermined state.

2. The method of claim 1, wherein the predetermined state is a prompt for the user to buy an in-game item.

3. The method of claim 1, wherein the predetermined state is a lack of an in-game item that is necessary to continue to play the game.

4. The method of claim 1, wherein the third predetermined state is a reduction to a cost to buy an in-game item.

5. The method of claim 1, wherein the first gaming application that is web browser executable includes JavaScript code.

6. The method of claim 1, wherein causing a source to source compiled application produced from source code of an application that is not web browser executable to execute in the web browser comprises:
compiling source code of the application that is not web browser executable to bitcode; and
source to source compiling the bitcode to a web browser executable format.

7. The method of claim 1, wherein the source to source compiled application is a virtual machine application that simulates an execution environment of a platform that is different than a platform on which the browser is executing, and wherein presenting the second gaming application comprises executing a second gaming application that is executable on the execution environment simulated by the virtual machine in the virtual machine to present the second gaming application.

8. The method of claim 7, wherein the virtual machine application is a Dalvik virtual machine application, and wherein the execution environment of the platform that is different than the platform on which the browser is running comprises an Android operating system.

9. The method of claim 7, wherein the virtual machine application is an x86 virtual machine running an Android operating system compiled for an x86 processor, and wherein the execution environment of the platform that is different than the platform on which the web browser is running comprises an Android operating system.

10. A system for presenting a gaming application in a web browser, the system comprising:
a web browser compatible application module configured to:
present a first gaming application that is web browser executable in the browser in response to a user request;
determine that the user has reached a predetermined state in the first gaming application;
responsive to determining that the user has reached the predetermined state, notify a converted web browser compatible application module to begin execution of a source to source compiled application produced from source code of an application that is not web browser executable in the web browser;
the converted web browser compatible application module configured to:
execute the source to source compiled application responsive to receiving the notification from the web browser compatible application module, the source to source compiled application presenting a second gaming application;
determine that the a second predetermined state has been reached in the second gaming application; and wherein the web browser compatible application module is configured to change the state of the first gaming application that is web browser executable to a third predetermined state responsive to reaching a second predetermined state in the second gaming application.

11. The system of claim 10, wherein the predetermined state is a prompt for the user to buy an in-game item.

12. The system of claim 10, wherein the third predetermined state is a reduction to a cost to buy an in-game item.

13. The system of claim 10, comprising:
a bit code compiler module configured to:
compile source code of the application that is not web browser executable to bitcode; and
a source to source compiler module configured to:
source to source compile the bitcode to a web browser executable format.

14. The system of claim 10, wherein the source to source compiled application is a virtual machine application that simulates an execution environment of a platform that is different than a platform on which the browser is executing, and wherein the converted web browser compatible application module is configured to present the second gaming application by at least executing a second gaming application that is executable on the execution environment simulated by the virtual machine in the virtual machine to present the second gaming application.

15. A machine readable medium that is not a transitory propagating signal, for presenting a gaming application in a web browser, the machine readable medium storing instructions, which when performed by a machine, cause the machine to perform operations comprising:
presenting a first gaming application that is web browser executable in the browser in response to a user request;
determining that the user has reached a predetermined state in the first gaming application;
responsive to determining that the user has reached the predetermined state, causing a source to source compiled application produced from source code of an application that is not web browser executable to execute in the web browser, the source to source compiled application presenting a second gaming application;
responsive to reaching a second predetermined state in the mobile based gaming application, changing the first gaming application that is web browser executable to a third predetermined state.

16. The machine readable medium of claim 15, wherein the predetermined state is a prompt for the user to buy an in-game item.

17. The machine readable medium of claim 15, wherein the predetermined state is a lack of an in-game item that is necessary to continue to play the game.

18. The machine readable medium of claim 15, wherein the third predetermined state is a reduction to a cost to buy an in-game item.

19. The machine readable medium of claim 15, wherein the first gaming application that is web browser executable includes JavaScript code.

20. The machine readable medium of claim 15, wherein the instructions for causing a source to source compiled application produced from source code of an application that is not web browser executable to execute in the web browser comprise instructions, which when performed by the machine, cause the machine to perform the operations comprising:
compiling source code of the application that is not web browser executable to bitcode; and
source to source compiling the bitcode to a web browser executable format.

21. The machine readable medium of claim 15, wherein the source to source compiled application is a virtual machine application that simulates an execution environment of a platform that is different than a platform on which the browser is executing, and wherein the instructions for presenting the second gaming application comprises instructions, which when executed by the machine, cause the machine to perform the operations comprising: executing a second gaming application that is executable on the execution environment simulated by the virtual machine in the virtual machine to present the second gaming application.

22. The machine readable medium of claim 21, wherein the virtual machine application is a Dalvik virtual machine application, and wherein the execution environment of the platform that is different than the platform on which the browser is running comprises an Android operating system.

23. The machine readable medium of claim 21, wherein the virtual machine application is an x86 virtual machine running an Android operating system compiled for an x86 processor, and wherein the execution environment of the platform that is different than the platform on which the web browser is running comprises an Android operating system.
